(19) United States
(12) Patent Application Publication
(10) Pub. No.: US 2011/0095881 A1
(43) Pub. Date: Apr. 28, 2011

(54) ALERT NETWORK SYSTEMS AND METHODS

(75) Inventors: Robert W. ROSENTEL, Nashua, NH (US); Arthur Eric Jones, Lawrenceville, NJ (US); Vincent C. Grosso, New York, NY (US)

(73) Assignee: Channel One, LLC, New York, NY (US)

(21) Appl. No.: 12/912,677

(22) Filed: Oct. 26, 2010

Related U.S. Application Data
(60) Provisional application No. 61/255,017, filed on Oct. 26, 2009.
(60) Provisional application No. 61/387,436, filed on Sep. 28, 2010.

(51) Int. Cl. G08B 23/00

(52) U.S. Cl. 340/501

(57) ABSTRACT

Alert network systems and methods are disclosed. In some embodiments, a method comprises receiving an emergency alert regarding an emergency condition affecting a geographic region, selecting a facility from a plurality of facilities based on at least the geographic region, generating an alert notification regarding the emergency alert, providing the alert notification to the selected facility, and receiving an authorization to provide emergency information to one or more digital devices associated with the facility.

### CROSS-REFERENCE TO RELATED APPLICATION

The present application claims benefit of U.S. Provisional Patent Application No. 61/255,017, filed Oct. 26, 2009, and entitled “Alert Network System and Method” and U.S. Provisional Patent Application No. 61/387,436 filed Sep. 28, 2010, and also entitled “Alert Network System and Method” which are both incorporated herein by reference.

### BACKGROUND

1. Field of the Invention

The present invention generally relates to providing alerts. More particularly, the invention relates to alert network systems and methods.

2. Description of Related Art

Safety is an issue of growing concern especially in the years after 9/11. Various disasters and emergencies may have an enormous impact on different facilities, particularly on schools and school children. While there are a number of very sophisticated alert systems for weather, including the creation of real time graphics and aural alerts through radio signals, other local agencies (e.g., such as those responding to chemical spills, local violent acts, and terrorism) do not have alert systems that are effectively distributed. Unfortunately, alerts from these systems do not reach facilities such as classrooms in a redundant and timely manner.

Many facilities are adding display devices and speakers at an increasing rate. For example, American schools contain or are adding image display devices, such as LCD screens, white boards, and video projectors, to school classrooms. Many schools have wired networks, such as “Channel One Network,” and TV sets or other screens.

Further, many display devices and/or speakers are usually active (i.e., “on”) during the course of the day or can be activated remotely when necessary. The multi-media experience elicited by these devices may have certain advantages to students and teachers. In order to communicate well, messages on the screens can contain images and text in one or many languages, can contain animated or graphic motion sequences outlining action. In spite of these technological resources, schools today typically rely on a public address (PA) system to relay important messages. Unfortunately, the PA system many times cannot be heard in classrooms, or is not working.

### SUMMARY OF THE INVENTION

Alert network systems and methods are disclosed. In some embodiments, a method comprises receiving an emergency alert regarding an emergency condition affecting a geographic region, selecting a facility from a plurality of facilities based on at least the geographic region, generating an alert notification regarding the emergency alert, providing the alert notification to the selected facility, and receiving an authorization to provide emergency information to one or more digital devices associated with the facility.

The emergency condition may be associated with a condition selected from the group consisting of weather, terrorism, shooting, accident, and chemical spill. The emergency alert may comprise information received from the NOAA Disaster Management Interoperability Services (DMIS). The alert notification may comprise a summary of the emergency condition and a proposed action to notify others.

In some embodiments, selecting the facility from the plurality of facilities based on at least the geographic region comprises searching a database for the plurality of facilities related to the geographic region and selecting one or more of the plurality of facilities that may be affected by the emergency condition. Selecting the facility may comprise selecting the facility at least partially based on a rule, wherein the rule comprises instructions that one or more facilities of the plurality of facilities should be contacted when the emergency condition has occurred in the geographic region. Providing the alert notification to the selected facility may comprise providing the alert notification to an authorization device associated with the facility.

The method may further comprise sending emergency information to the one or more digital devices associated with the facility based on the authorization. The emergency information may comprise audio, video, and images associated with the emergency condition. The emergency information may comprise a map. Further, the emergency information may comprise customized messages generated by authorized users associated with the facility.

An exemplary system may comprise a notification receiver module, a facility selection module and an emergency transmission module. The notification receiver module may be configured to receive an emergency alert regarding an emergency condition affecting a geographic region. The facility selection module may be configured to select a facility from a plurality of facilities based on at least the geographic region. The emergency transmission module may be configured to generate an alert notification regarding the emergency alert, provide the alert notification to the selected facility; and receive an authorization to provide emergency information to one or more digital devices associated with the facility.

An exemplary computer readable medium may comprise executable instructions. The instructions being executable by a processor to perform an exemplary method. The method may comprise receiving an emergency alert regarding an emergency condition affecting a geographic region, selecting a facility from a plurality of facilities based on at least the geographic region, generating an alert notification regarding the emergency alert, providing the alert notification to the selected facility, and receiving an authorization to provide emergency information to one or more digital devices associated with the facility.

### BRIEF DESCRIPTION OF THE DRAWINGS

FIG. 1 depicts an incoming alert notification network in some embodiments.

FIG. 2 is a block diagram of an inbound alert network in some embodiments

FIG. 3 is an environment for inbound alert messaging in some embodiments.

FIG. 4 is box diagram of an alert server in some embodiments.

FIG. 5 is a flow diagram depicting the communication between the alert server, emergency notification center, emergency administrator device, and presentation device in some embodiments.

FIG. 6 is a flow chart to present emergency information at a presentation device in some embodiments.

FIG. 7A-7C depict different displays presenting different emergency information in some embodiments

FIG. 8 is an exemplary digital device in some embodiments.

### DETAILED DESCRIPTION OF THE INVENTION

In various embodiments, an inbound alert network may provide facility-specific timely emergency information. In one example, the inbound alert network may provide site-specific, timely severe weather alerts from the National Oceanic and Atmospheric Administration (NOAA) and the National Weather Service. The network may, in some examples, may also support a message network for alerts from the Department of Homeland Security, FEMA, or any other service to any facility such as a school. Messages provided to facilities may enhance safety by displaying media (e.g., audio, still images and/or moving images) using any kind of device (e.g., TV display devices) on wired and wireless networks.

For example, systems and methods described herein may send emergency information (Inbound Alerts) to the administrative staff within school buildings. In various embodiments, systems and methods described herein create continuity across school districts and provide school/district administrators with current site specific relevant and accurate information to make the decisions to keep students and staff safe. Emergency information may include customized emergency plans and/or messages which may be distributed to one or more classrooms (e.g., at the direction of the principal). The emergency information may be displayed on any digital device (e.g., televisions, interactive white boards, personal computers, personal digital assistants or cell phones) and/or provided to any other device (e.g., intercoms, speaker systems, or radio). For example, emergency information may be provided directly into a classroom (at direction of the Principal) on existing communication platforms from TVs, interactive white boards, personal computers and intercoms in each school.

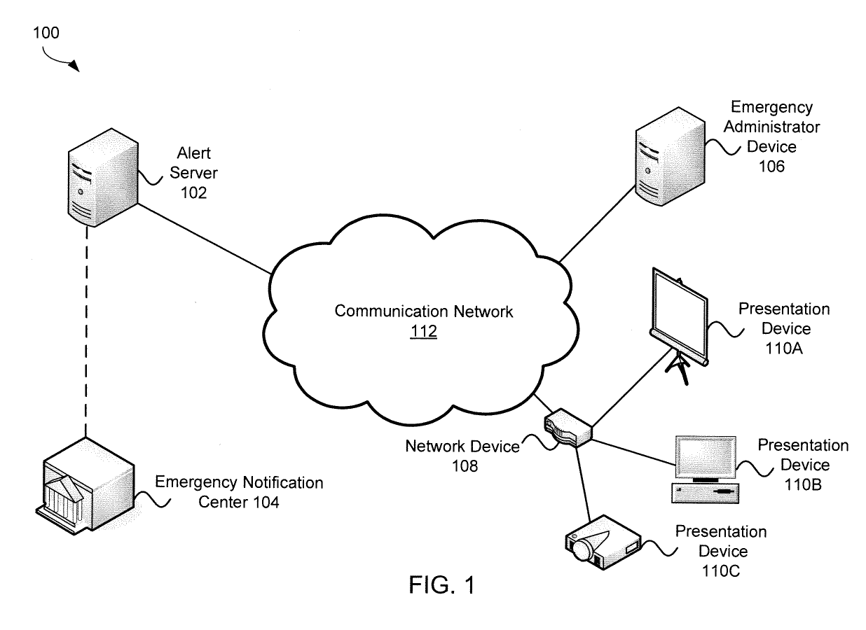

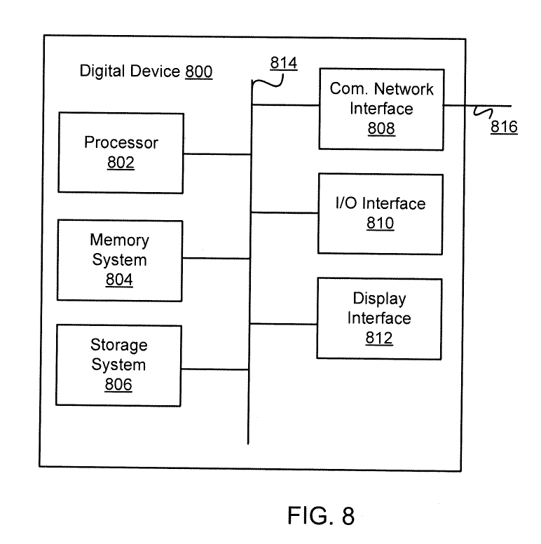

FIG. 1 depicts an inbound alert network 100 in some embodiments. The inbound alert network 100 comprises an alert server 102, an emergency notification center 104, an emergency administrator device 106, and a network device 108 which may communicate over a communication network 112. In some embodiments, presentation devices 110A-C may communicate over a separate network, directly with the network device 108, and/or the communication network 112. The alert server 102, emergency notification center 104, emergency administrator device 106, network device 104, and one or more of the presentation devices 110A-C may comprise digital devices. A digital device is any device with a processor (e.g., computer) and memory. A digital device is further described in FIG. 8.

In various embodiments, the alert server 102 is the central “hub” through which information flows. Emergency alerts, such as alerts from NOAA, may flow to the alert server 102. The alert server 102 may then process the emergency alert. In one example, the alert system 102 determines the geographic area affected by the emergency associated with the emergency alert. The alert system 102 may then select one or more facilities associated with the geographic area that may be affected by the emergency alert. One or more messages comprising emergency information and/or notifications may be provided to the facility. An emergency administrator device 106 may receive the message and/or notifications and authorize action (e.g., the emergency administrator device 106 authorizes that all or some of the message be provided to the presentation devices 110A-C.

Emergency information may comprise any kind of data including audio, video, images, and/or maps. Further, the emergency information may be multimedia. The emergency information may be the creation of rules. In one example, the alert server 102, emergency administrator device 106, and/or the network device 108 may generate the message and/or emergency information based on rules associated with the facility. For example, a multimedia alert messages may be generated by the alert server 102 or may be by the creation of an instruction set which may tell the emergency message controller how to build multimedia alert messages directly at the facility location.

The alert server 102 is a digital device configured to receive one or more emergency alerts from the emergency notification center 104. The emergency notification center 104 is any device capable of providing emergency alerts such as NOAA, National Weather Service (NWS), Homeland Security, Sky Warn, local radio stations, local television stations, Internet sites, or the like. The alert server 102 may receive emergency alert regarding any kind of emergency including both national and local alerts. An emergency alert is any message notifying one or more users and/or devices of an emergency or alert condition. In some examples, the emergency alert may include but be not limited to a tornado warning, tornado watch, fire, riot, flood, chemical accident, environmental disaster, hurricane, shooting, or the like. In another example, the emergency alert may be received from the NOAA Disaster Management Interoperability Services (DMIS), which is the system that currently distributes alerts for the National Weather Service and other agencies.

In one example, the emergency notification center 104 determines or notifies one or more devices that a tornado warning is in effect for three counties. The emergency notification center 104 may provide an emergency alert regarding the tornado warning in any number of ways including, but not limited to, television broadcast, web page, e-mail, telephone calls, broadcast over speakers, telephone calls, text message (SMS) or the like.

The alert server 102 may receive one or more emergency alerts from one or more emergency notification centers 104 in one or more different ways. In one example, the alert server 102 may receive an emergency alert directly from the emergency notification center 104, from over a radio broadcast, and/or from a web page. Further, in some examples, the alert server 102 may receive emergency information from any number of sources, including but not limited to television broadcast, web page, e-mail, telephone calls, broadcast over speakers, call to cell phones, text message (SMS), radio broadcast, computer alert, short wave radio, data message, and/or Internet message.

After an emergency alert is received, the alert server 102 may identify one or more facilities associated with the emergency alert. A facility is any structure (e.g., building) or combination of structures (e.g., a campus or school). For example, if the emergency alert indicates that a region is at risk (e.g., 3 counties are under a tornado warning), the alert server 102 may identify one or more facilities associated with the region. In some embodiments, the alert server 102 comprises a database of facilities. The database may comprise metadata indicating geographic location of the facility and/or likelihood of action depending on the emergency alert.

After one or more facilities are identified as being associated with an emergency alert, the alert server 102 may cause emergency information to be provided via the presentation device 110A-C. In one example, emergency information may be generated by the alert server 102 and/or the network device 108. The emergency information may be provided to the presentation devices 110A-C.

In some embodiments, there are three types of messages that may be delivered including:
1) Alert Notification—A real-time alert sent to an emergency administrator's device (e.g., district box and/or Principal's Box) based on a triggering event from NOAA or other emergency notification service.
2) Emergency Information—Prepackaged alerts for various subjects preloaded on the facility server with the ability to insert Principal's Text screens into the Alert if desired
3) Text message notification—Messages sent to cell phones to notify school staff of the occurrence of the alert and alert type (this text message may be intended for school or district personnel staff only and may not intended to replace an emergency call or email system offered by other vendors that allow a school to contact parents at home or on cell phones or email with school closings, etc.)

Those skilled in the art will appreciate that for the purposes of this spec, the term “server” may be used to indicate a server daemon, rather than a physical piece of hardware. The term “server” to describe a set of software programs which interact with one-another to produce a desired result.

The emergency administrator device 106 is a digital device configured to authorize distribution of emergency information to the presentation devices 110A-C. In one example, an administrator such as a principal or superintendent may control the emergency administrator device 106 to authorize contact with one or more facilities based, at least in part, on the alert notification and/or the emergency alert. In some embodiments, the emergency administrator device 106 may receive an alert notification from the alert server 102 indicating that the alert server 102 has received one or more emergency alerts from one or more emergency notification centers 104. The alert notification may include a summary of the emergency alert and/or alert conditions as well as indicate all or some of the facilities that may be affected.

Based on the alert notification and/or the emergency alert, the administrator and/or the emergency administrator device 106 may authorize distribution of emergency information. In some embodiments, the emergency administrator device 106 may control which facilities and/or presentation devices 110A-C may receive emergency information. The emergency administrator device 106 may also determine what information to include in the emergency information and how the information will be presented to one or more of the presentation devices 110A-C.

Those skilled in the art will appreciate that the emergency administrator device 106 may be optional. In some embodiments, playback of an emergency message may be at the discretion of designated personnel and/or devices (e.g., an emergency administrator device 106), who may first verify their identity with the emergency message controller, emergency administrator device and/or the alert server 102.

In various embodiments, the emergency administrator device 106 comprises custom software which requires password or encrypted authentication. The emergency administrator device 106 may generate log files for all actions and, in some embodiments, generate a status report at intervals of time.

Those skilled in the art will appreciate that communication between the alert server 102 and the emergency notification center 104, the emergency administrator device 106, and/or the network device 108 may be encrypted or otherwise secured (e.g., via a virtual private network or other tunneling). In various embodiments, the alert server 102 authenticates each digital device and tracks identifiers. An identifier may comprise an IP address, MAC address, software address, session identifier, or any other identifier or combination of identifiers. In various embodiments, the emergency administrator device 106 is located at an administrative office and is secured (e.g., the emergency administrator device 106 is physically secured, with no floppy drives or CD Rom, and/or USB boot is disabled).

The network device 108 is a device that is configured to provide emergency information to one or more presentation devices 110A-C. In one example, a building, facility, or part of a facility may comprise one or more network devices 108. In some embodiments, the network device 108 receives emergency information from the alert server 102.

In other embodiments, the network device 108 stores emergency information. For example, emergency information may be customized and stored in the alert server 102 and/or the network device 108. When an emergency alert is received by the alert server 102, the alert server 102 may provide instructions to the network device 108 to retrieve and distribute one or more previously stored messages (i.e., the emergency information). In another example, the network device 108 may generate emergency information by retrieving information from the alert server 102, emergency alert(s), and/or facility information before distributing the emergency information.

The presentation devices 110A-C may be any device capable of presenting emergency information. The presentation devices 110A-C may be any device with a screen and/or speaker.

The communication network 112 may be any network. In one example, the communication network 112 is the Internet. The communication network 112 may comprise one or more networks of different types (e.g., wired or wireless). In some embodiments, the alert server 102 and the network device 108 communicate over the communication network 112 using IP (e.g., TCP-IP).

In various embodiments, the alert server 102 comprises and/or retrieves rules including authorization rules, message rules and distribution rules. An authorization rule provides instructions regarding the process required for authorization, if any. For example, authorization rules for a particular facility may instruct the alert server 102 to require authorization from two or more identified emergency administrator devices 108 before distributing emergency information. The authorization rules may also identify the emergency administrator device 106 and include information necessary to establish a secure connection (e.g., encryption key).

A message rule may instruct the alert server 102 or other digital device regarding generation of emergency information. For example, one or more message rules may instruct the alert server 102 to generate a message comprising maps of a particular facility for evacuation, instructions, audio from the administrator describing the instructions, and text from an emergency alert received from the emergency notification center 104. In various embodiments, the message rules may be established, at least in part, by administrators associated with the facility and may be different depending on the facility, the administrator, and/or the emergency.

A distribution rule determines what facility and/or presentation device may receive emergency information. In some embodiments, the distribution rule instructs the alert server 102 to send some types of emergency information (e.g., maps, text, an audio) to some presentation devices (e.g., presentation device 110A), only audio to others (e.g., a PA or other speaker system), and only display information to others (e.g., a whiteboard without a speaker).

Those skilled in the art will appreciate that emergency alerts, alert notification, and emergency information may be sent and received in a timely manner. In some embodiments, the target time gap between receiving the emergency alert from emergency notification center 104 and delivering the alert to the emergency administrator device 106 is 2 minutes or less.

In some embodiments, emergency alerts, alert notifications, and/or emergency information are logged in a centralized database. Information associated with a facility, including but not limited to identifiers, e-mail addresses, MAC addresses, IP address, and metadata, may be maintained in a facility information database. The facility information data may include detailed geographic location information associated with one or more facilities and technical support history. Detailed contact information for personnel who are approved to interact and/or authorize action related to systems and methods described herein may be maintained in the facility information database and/or rules database.

In various embodiments, the alert server 102 issues scheduled inbound alert test messages to verify operational status. Test messages may be sent to any digital device to test functionality of the communication network 112. Test messages may be similar to those currently being used by the national Emergency Broadcast System or other emergency notification systems. Those skilled in the art will appreciate that the alert server 102 may comprise a log module which probes and/or monitors the status of the one or more alert servers 102, emergency administrator devices 106, network devices 108, and/or display devices 110A-C.

Upon determination that a network or device is unavailable, the alert server 102 may notify one or more people or devices for correction. For example, upon detection that an emergency administrator device 106 is unavailable, the alert server 102 may retrieve contact information associated with the unavailable device and provide messages (e.g., text message, SMS, e-mail, or telephone call) to indicate that the device is unavailable and assistance may be required.

Although only a single alert server is depicted in FIG. 1, those skilled in the art will appreciate that there may be any number of alert servers. For example, a plurality of servers, including redundant servers, may be geographically dispersed in order to provide fail-over in the event of system outages. Similarly, there may be any number of emergency notification centers 104, emergency administrator devices 108, network devices 108, and presentation devices 110A-C.

The alert server 102 may provide around-the-clock services and may be have the ability to take various systems offline without disrupting service. Since network connections to the network device 108 and/or presentation devices 110A-C can become a point of failure, the alert server 102 may communicate with the emergency administrator device 106, network device 110 and/or presentation devices 110A-C through redundant connections.

Those skilled in the art will appreciate that one or more people and/or devices may trigger a facility alert without interaction with the alert server 102. A facility alert may be a pre-packaged customized message stored on the network device 108. The facility alert may be a combination of predefined location-specific media components along with real-time text screens generated on a designated device (e.g., a Principal's device by the Principal or staff at a school or the emergency administrator device 106). The ability to trigger a facility alert may require verification of identity.

Those skilled in the art will appreciate that systems and methods described herein may comprise an end to end digitally based alert signaling network to sites operating on a variety of distribution systems. The system may be designed to be functionally independent and redundant to other communications paths.

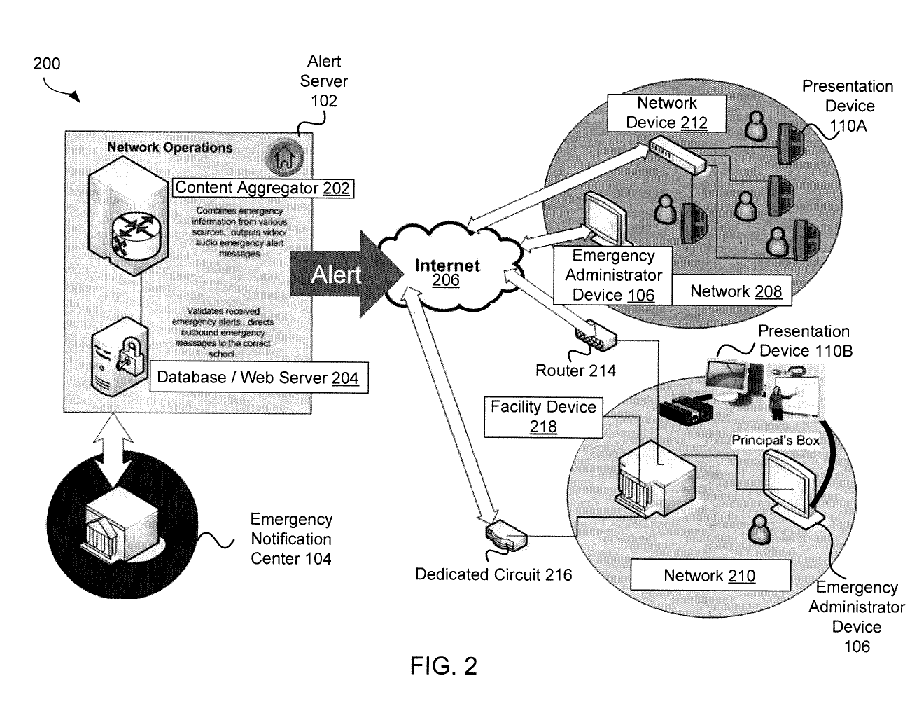

FIG. 2 is a block diagram of an inbound alert network 200 in some embodiments. In various embodiments, the inbound alert network is a redundant and reliable communications system capable of delivering broadcast warnings and emergency information directly to the public via video screens and other devices on all analog, digital, or IP-based networks. The inbound alert network may be configured to use satellite-based distribution networks and other forms of communication systems and protocols. The inbound alert network may use as a redundant alert mechanism to and from Emergency Communications Centers (ECC-911) and other sources around the country. Since the inbound alert network may be compatible with Internet Protocol (IP)-based digital video, widespread delivery in the home, K-12 schools, institutions of higher education, and public spaces may be achievable via mass-market display devices which are already in place. The inbound alert network may work with the standards and interoperability currently used by government agencies, such as the National Oceanic and Atmospheric Administration (NOAA), United States Geological Survey (USGS), Federal Emergency Management Agency (FEMA), national first responder associations such as the National Emergency Number Association (NENA) and local law enforcement to receive alert information.

The inbound alert network 200 may comprise the alert server 102, the emergency notification center 104, the network 208, and the network 210 which communicate over the Internet 206. The alert server 102 may comprise a content aggregator 202 and a database/web server 204. The content aggregator 202 allows for the customization of emergency information for distribution to one or more facilities. For example, the content aggregator 202 may allow a user to generate a customized message to include specific images, video, and notifications. Once these customized messages are stored, the alert server 102 may retrieve the messages when one or more emergency alert associated with the customized messages are received.

In some embodiments, the content aggregator 202 generates emergency information when needed based on message rules. In one example, the alert server 102 may receive an emergency alert, identify affected facilities, and retrieve one or more message rules indicating, for example, how to generate emergency information. The content aggregator 202 may retrieve images, audio, and/or video that was previously stored to generate the emergency information. Further, information from the emergency alert or websites associated with the emergency alert may also be included in the emergency information. For example, a display of a map of evacuation plans may include running text at the bottom of the display that is taken from a feed at the emergency notification center 104.

The database/web server 204 is configured to validate emergency alerts (e.g., by confirming the alert and contacting the emergency notification center 104 for confirmation). The database/web server 204 may also be configured to direct outbound emergency messages to the selected facility based on the emergency alert and/or facility rules associated with the emergency alert.

The alert server 102 is configured to receive material from emergency notification centers 104 (e.g., NOAA or WARN). The alert server 102 may be configured to create customized graphics and output alert notification and/or emergency information to a distribution server. The alert server 102 may be capable of pulling information from emergency notification center(s) 104, be scalable with still, moving images and audio protocols, compatible with 911 alert servers, WARN servers, etc., and capable of receiving input from local facilities.

The alert server 102 may communicate with any kind of network including, but not limited to network 208 and network 210. Network 208 comprises an emergency administrator device 106, a network device 212, and any number of presentation devices 110A. Network 210 comprises a facility device 218, emergency administrator device 106, and presentation devices 110B. Those skilled in the art will appreciate that the alert server 102 may provide emergency information to networks with a network device 212 (e.g., network 208) or without a network device 212 (e.g., network 210).

In some embodiments, the alert server 102 may provide emergency information to be stored in the network device 212. For example, images, audio, video, and/or messages regarding different alerts may be stored in the network device 212 to provide to one or more presentation devices 110A upon receiving authority to distribute emergency information by the emergency administrator device 106. Those skilled in the art will appreciate that, in some embodiments, the presentation devices 110A may be activated and/or configured to receive the emergency information remotely (e.g., via software resident in the presentation device 110A, the network device 212, and/or the alert server 102). In one example, a manager of the alert server 102 may activate and/or configure the presentation devices 110A to receive emergency information during an emergency and/or when authorized by the emergency administrator device 106. In another example, an administrator associated with the facility or network 208 may activate and/or configure the presentation devices 110A.

The alert server 102 may provide emergency information to the network 210. In some embodiments, the alert server 102 may receive authorization to distribute emergency information from the emergency administrator device 106 or any authorized user. The facility device 218 may be any digital device capable of receiving and distributing the emergency information to the presentation devices 110B and/or the emergency administrator device 106 (e.g., the principal's box). The facility device 218 may be a router. In some embodiments, the emergency administrator device 106 controls the presentation devices 110E either automatically or manually and may make the determination to provide the emergency information.

Those skilled in the art will appreciate that emergency information is not always “pushed” from the alert server 102 to the networks. For example, if an administrator or other qualified personnel determine that an emergency condition may be present, they may check with the alert server 102 to determine or confirm if there is an emergency alert affecting one or more facilities. The administrator or other qualified personnel may request emergency information from the alert server 102 to provide to the presentation devices 110B.

The alert server 102 may communicate with the network 208 and/or the network 210 in any number of ways including over the Internet 206. The alert server 102 may also communicate via a router 214 in communication with the Internet 206 or a dedicated circuit 216. Those skilled in the art will appreciate that the alert server 102 may communicate with the networks 208 and 210 through multiple, redundant means.

In one example, the inbound alert network 200 is an end to end digitally based alert signaling network to facilities such as schools. The network may, for example, operate on a quarter transponder (¼) of satellite transponder with reception on receiving dishes located in buildings and/or facilities (e.g., K-12 schools) nationwide. The inbound alert network 200 may be designed to be functionally independent and redundant of other communications paths. The digital stream may be transmitted via a standard video transmission method using MPG-4 to a network device. The network device 200 may be configured to store and display an image based MPG-4 video file over a conventional coax CATV system. The inbound alert network 200 may be configured to address the network device as well as other satellite based receivers operating in a similar manner with the same protocols.

In some embodiments, the alert server 102 comprises a facility data comparator that is configured to receive periodic data on the readiness of each facility based on a predetermined schedule. The facility data comparator may also receive readiness data input (e.g., graphic maps and data).

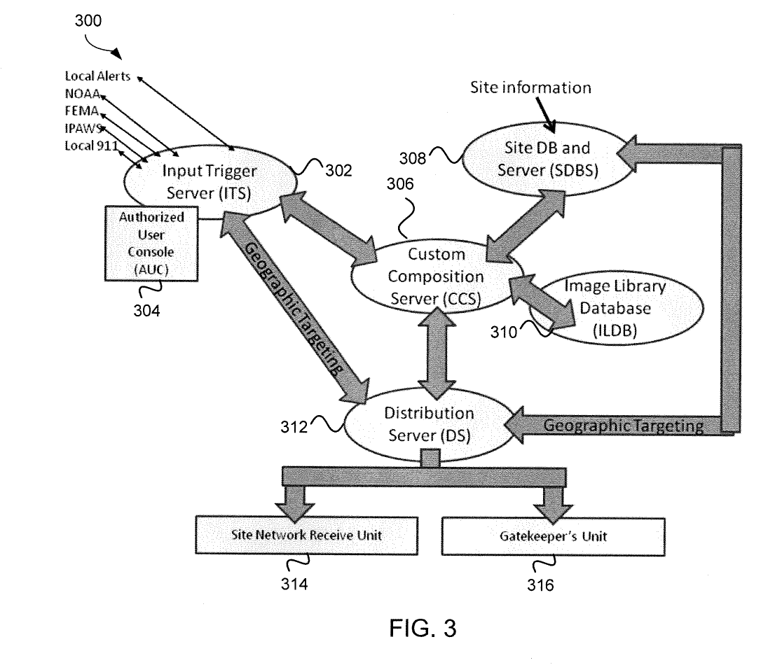

FIG. 3 is an environment 300 for inbound alert messaging in some embodiments. The environment 300 comprises an input trigger server 302, an authorized user console 304, a custom composition server 306, a site database and server 308, an image library database 310, a distribution server 312, a site network receive unit 314, and a gatekeeper's unit 316. those skilled in the art will appreciate that the input trigger server 302, authorized user console 304, custom composition server 306, site database and server 308, image library database 310, distribution server 312, site network receive unit 314, and the gatekeeper's unit 316 may comprise one or more digital devices. In one example, a system (e.g., one or more computers) may comprise or perform the functionality of the input trigger server 302, authorized user console 304, custom composition server 306, site database and server 308, and image library database 310, while another system may comprise or perform the functionality of the distribution server 312, site network receive unit 314, and/or the gatekeeper's unit 316.

The input trigger server 302 is a digital device configured to receive emergency alerts (e.g., local, NOAA, FEMA, IPAWS, Local 911) and control the process of providing appropriate emergency information and/or alert notification to the distribution server 312. In some embodiments, the input trigger server 302 may comprise or perform the functionality of the alert server 102 of FIG. 1. In various embodiments, the input trigger server 302 is configured to receive data and targeting information (e.g., geographic information of an area affected by an event or emergency) from a variety of sources including NOAA, IPAWS, FEMA, local 911, etc. The input trigger server 302 may be configured to accept the information protocols for various sources of alert information.

The authorized user console 304 is configured to provide triggering information to the input trigger server 302. In various embodiments, the authorized user console 304 is an interface, such as a graphical user interface, provided by the input trigger server 302. In other embodiments, the authorized user console 304 comprises a separate digital device from the input trigger server 302 (e.g., a web server that communicates with the input trigger server 302).

The authorized user console 304 may authorize the input trigger server 302 to provide an alert notification and/or emergency information to the distribution server 312. Without the authorization of the authorized user console 304 or a user of the authorized user console 304, the input trigger server 302 may not, in some embodiments, provide information to the distribution server 312. In one example, the input trigger server 302 may receive an emergency alert from FEMA and send a notification to the authorized user console 304 to alert the authorized user console 304 that an emergency alert has been received. The user of the authorized user console 304 may review the emergency alert and authorize the input trigger server 302 to identify affected facilities, send one or more alert notifications to the affected facilities, and prepare emergency information for distribution.

In another example, after an emergency alert is received by the input trigger server 302, the input trigger server 302 may request an authorization from the authorized user console 304 and provide the received emergency alert, a list of possibly affected facilities, proposed alert notifications, and/or proposed emergency information. The user of the authorized user console 304 may authorize sending the alert notifications or the emergency information. Further, a user of the authorized user console 304 may add or subtract identified facilities based, in part, on the emergency alert, modify one or more alert notifications, modify the emergency information, and/or request or retrieve additional information regarding the emergency alert (e.g., search for more information).

In some embodiments, the authorized user console 304 manages multi-level permissions and authorizations of users. The authorized user console 304 may allow for the creation, targeting and triggering of an alert manually (e.g., regardless if an emergency alert was received from another source). For example, a police officer or fire chief may trigger an alert for an emergency condition. The authorized user console 304 may serve as the security and front-end of the input trigger server 302 and may monitor the health of the system (e.g., uptime of the input trigger server 302, network, status of one or more site network receive units 314 and/or the gatekeeper's unit 316).

The input trigger server 302 and/or the custom composition server 306 may allow for customization of emergency information. In various embodiments, a user at one or more facilities, the input trigger server 302, and/or an authorized user may customize the emergency information and/or the alert notification. For example, a school district may customize an emergency alert for a tornado watch by including a map of a building directing occupants to safe areas such as a basement or other secure location. Emergency information may include, but is not limited to, pictures (e.g., building maps, instructions, weather maps, and/or examples), audio (e.g., warnings and/or instructions), text (e.g., a scrolling footer describing the nature of the emergency as well as contact information), or any other kind of media or combination of media.

In some embodiments, emergency information is customized to receive information from one or more emergency alerts. For example, emergency information may comprise directions to a safe area in a facility, safety instructions, and text scrolling at the bottom of the message from one or more emergency alerts. In another example, emergency information may comprise a display indicating the emergency condition followed by a display of directions to safety and instructions. Another display may then present information from one or more emergency alerts. Those skilled in the art will appreciate that the emergency information may comprise any kind of information from multiple sources.

In some embodiments, a user accesses the custom composition server 306 to generate emergency information. The custom composition server 306 may pull information from one or more emergency alerts (e.g., NOAA or WARN servers), websites, or information from site database and server 308 and/or image library database 310. The user may select images, video, or other media from the image library database 310 and/or select site specific information (e.g., location, maps, safety equipment, or instructions to some of the occupants of the site) from the site database and server 308. The customized emergency information may be stored at the input trigger server 302, the custom composition server 206, the site database and server 308, the image library database 310, the distribution server 312, and/or the gatekeeper's unit 316.

In some embodiments, an administrator or other user may prepare different emergency information for different facilities, buildings, emergencies, or the like. For example, an administrator of a school district may generate customized emergency information and include individual maps for each floor or area of a facility (e.g., directions to exits) or instructions for different emergencies (e.g., to stay in one location, exit the building, or move to a safe location). Any number of authorized users (e.g., an inbound alert professional and a facility administrator) may create emergency information.

The site database and server 308 and the image library database 310 may be any kind of data storage. The site database and server 308 may store site information such as, but not limited to, site-specific data and graphics which may be used to customize emergency information. The site database and server 308 may be configured to store information regarding facilities, addresses, contacts, information regarding one or more site network receive units 314 (e.g., IP address and/or rules regarding when to distribute emergency information, name, Site ID, street address, and/or geocoding), information regarding one or more gatekeeper's units 316 (e.g., IP address, rules regarding when to distribute emergency information, rules regarding when authorization is required, name, Site ID, street address, geocoding username(s) and password(s) of one or more gatekeepers, or the like). Site specific alert information regarding different facilities may include language, audience composition (e.g., school grade level), special needs (e.g., hearing impaired population), geography of site, relevant floor plans and maps of evacuation, personalized video messages from local authority figure(s), keywords best used in alerts for this site (e.g., “warning” or “watch”), or emergency drill information (e.g., fire drill experience).

The image library database 310 may store images, sounds, and text files that may be used by the custom composition server 306 to create customized emergency information. In another example, the custom composition server 306 may create a rule to include information from one or more emergency alerts (e.g., with standard input I/O with NOAA weather protocol) when available (e.g., still images, video, and/or audio) but to pull media from the image library database 310 when information from the emergency alert is not available.

The distribution server 312 is configured to distribute the alert notification and/or the emergency information received from the input trigger server 302 and/or the custom composition server 306. In one example, the distribution server 312 may receive an alert notification indicating an emergency condition based on an emergency alert received by the input trigger server 302. The distribution server 312 may direct the alert notification to one or more affected facilities based on facilities identified by the input trigger server 302. Those skilled in the art will appreciate that the distribution server 312 may transcode alert notification(s) and/or emergency information to appropriate codecs as necessary by different receiving devices (e.g., site network receive unit 314 and/or the gatekeeper's unit 316).

The gatekeeper's unit 316 is configured to authorize distribution of the emergency information to the site network receive unit 314. In some embodiments, the gatekeeper's unit 316 is a secondary store that is configured to receive and store emergency information from the input trigger server 302, the custom composition server 306, and/or the distribution server 312. In some embodiments, the gatekeeper's unit 316 may receive an alert notification from the input trigger server 302 via the distribution server 312 which indicates that one or more emergency alerts have been issued which may affect one or more facilities associated with the gatekeeper's unit 316. An authorized user (e.g., gatekeeper) may preview the emergency information, one or more emergency alerts, or any other information prior to authorizing distribution of the emergency information (e.g., to the site network receive unit(s) 314).

Those skilled in the art will appreciate that, in some embodiments, the gatekeeper's unit 316 may be bypassed either with or without the permission of the gatekeeper. For example, the input trigger server 302 may instruct the distribution server 312 or the gatekeeper's unit 316 to distribute the emergency information without authorization (e.g., upon receiving one or more emergency alerts that indicate a direct threat to the facility). In some embodiments, distribution rules which may be approved by authorized users associated with the facility, may indicate what emergency conditions may require immediate distribution of emergency information without other authorization. For example, emergency information may be distributed to a college campus when an emergency alert indicates a shooting or other violent condition.

The site network receive unit 314 is any digital device configured to display or perform the emergency information. As discussed herein, the site network receive unit 314 may comprise a display device, audio device, or any device which displays and/or plays media (e.g., via a screen and/or speakers).

In one example of the environment 300, NOAA generates a severe thunderstorm alert (i.e., emergency alert) for a specific county in a specific state. The NOAA data includes maps, audio, and text. The input trigger server 302 receives and sends the data to the custom composition server 306. The custom composition server 306 pulls additional graphics and backgrounds from the image library database 310 and the data and media from NOAA then creates a customized message (e.g., emergency information) based on the information provided and the facility information using information pulled from the site database and server 308. The completed emergency information (possibly in multiple versions) is sent to the distribution server 312 which may transcode the emergency information to the proper CODEC as needed for the targeted networks. The distribution server 312 may create the needed target groups with information from the input trigger server 302 (e.g., the targeted county) being sent over the required networks. The emergency information may be received in the various sites and the Gatekeepers Box may generate a sound or perform another activity for attention. The gatekeeper may review an alert notification and/or emergency information and instruct the local site operator to trigger the playout of the emergency information to the local screens.

Those skilled in the art will appreciate that although emergency information is discussed herein, information regarding events may also be distributed. For example, information regarding news events, disaster relief, or emergency conditions in other parts of a city, county, state, country, or world may be distributed in a manner similar to one or more systems and methods described herein.

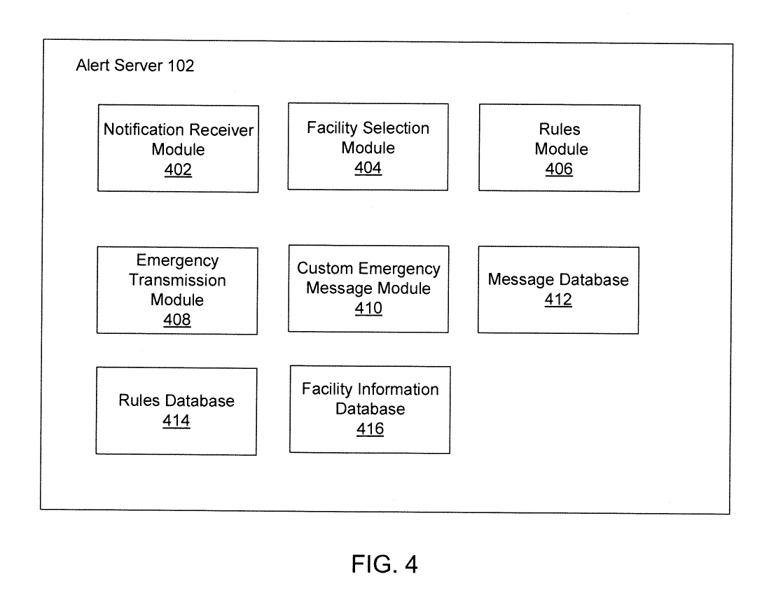

FIG. 4 is box diagram of an alert server 102 in some embodiments. The alert server 102 comprises a notification receiver module 402, a facility selection module 404, a rules module 406, an emergency transmission module 408, a custom emergency message module 410, a message database 412, a rules database 414, and a facility information database 416.

The notification receiver module 402 is configured to receive or retrieve emergency alerts. In some embodiments, the receiver module 402 receives or retrieves one or more emergency alerts from one or more emergency notification centers 104. In one example, the emergency notification center 104 contacts the alert server 102 and provides one or more emergency alert and/or other information regarding an emergency condition.

In another example, the notification receiver module 402 may monitor radio, television, and/or other communication mediums to detect an emergency condition. Once an emergency condition is detected the notification receiver module 402 may record or retrieve information regarding the emergency condition from many sources including one or more emergency notification centers 104 or mediums. In some embodiments, the notification receiver module 402 notifies an authorized user when an emergency condition has been detected. The notification receiver module 402 may then receive the emergency alert from the authorized user and/or other information regarding the emergency condition.

The facility selection module 404 is configured to determine if one or more facilities are may be affected by an emergency. In one example, geographic information is contained within the emergency alert. The facility selection module 404 may retrieve geographic information associated with one or more facilities from the facility information database 416 to compare to the geographic information from the emergency alert. For example, if there is a tornado warning for several counties close to Fort Worth, Tex., the facility selection module 404 may identify any facilities that may be affected by the tornado warning (e.g., facilities in those counties). The facility selection module 404 may retrieve metadata associated with a plurality of facilities from the facility information database 416.

In some embodiments, the facility selection module 404 may confirm selection of one or more facilities. For example, after a facility is selected, the facility selection module 404 may retrieve additional information to confirm that the facility may be threatened by an emergency condition or if the facility is not threatened (e.g., the threat has already past that particular facility). Further, the facility selection module 404 may confirm the selection of the facility by receiving additional information regarding the emergency condition. For example, the notification receiver module 402 may retrieve multiple emergency alerts regarding the same emergency condition. The facility selection module 404 may select a facility if any one of the emergency alerts may impact a facility.

The rules module 406 is configured to retrieve and execute rules from the rules database 414. As discussed herein, rules may comprise authorization rules, message rules and distribution rules. The distribution rules may govern when and where to provide alert notifications and/or emergency information. In one example, after the facility selection module 404 selects a facility, the rules module 406 may retrieve a distribution rule associated with the selected facility from the facility information database 416. The distribution rule may indicate when contact is to be made with an emergency notification center 104, network device 108, and/or presentation devices 110A-C. For example, the distribution rule may indicate that a facility is closed between certain hours (e.g., a school is closed at 2 AM) and, as a result, even if there is an emergency condition (e.g., tornado warning) that may affect the facility, the facility need not be notified. Those skilled in the art will appreciate that there may be any number of distribution rules affecting when an alert notification and/or emergency information should be provided. Distribution rules may also determine whether an alert should be sent to a specified site based on alert type and severity (e.g., a specific site may elect not to be notified for a “Flash Flood Watch” and create a distribution rule to that effect).

The emergency transmission module 408 is configured to provide the alert notification and/or emergency information to the emergency administrator device 106, network device 108, and/or presentation devices 110A-C. In some embodiments, the rules module 406 instructs the emergency transmission module 408 to provide one or more alert notifications to one or more emergency administrator devices 106. For example, an authorization rule may indicate that when an emergency alert is received that affects a particular facility, the emergency transmission module 408 is to provide an alert notification summarizing the emergency alert to one or more emergency administrator devices 106. The authorization rule may also indicate whether one or more authorizations are required prior to distribution of the emergency information to one or more network devices 108 and/or one or more presentation devices 110A-C. For example, before emergency information is provided to presentation devices 110A-C in an elementary school, an authorization rule may require that authorization be received from a superintendent's emergency administrator device 106 as well as a principal's emergency administrator device 106. Once the emergency transmission module 408 determines that all authorizations have been received based on the authorization rule, the emergency transmission module 408 may provide the emergency information.

The custom emergency message module 410 is configured to customize emergency information for distribution. Emergency information may be customized in many ways based on the emergency alert, an authorized administrator, facility, network device 108 and/or presentation device. For example, different maps may be included for evacuation depending on where a presentation device is located and the intended recipients (e.g., Spanish speaking, grade school age, healthy, or handicapped). Further an administrator may include different instructions, either verbally or visually, as a part of the emergency information to be presented.

In some embodiments, an authorized user (e.g., authorized administrator) customizes messages for different possible emergency alerts for different facilities and/or presentation devices. When an emergency condition exists, the custom emergency message module 410 may retrieve preconstructed messages, images, video, and audio from the message database 412. The custom emergency message module 410 may also be configured to include information from the emergency notification center 104 or other sources (e.g., scrolling text indicating the latest updates of the emergency condition and/or the emergency alert).

Once the custom emergency message module 410 generates the emergency information (which may include custom emergency messages) the emergency transmission module 408 may provide the emergency information to one or more network device 108 and/or presentation devices 110A-C based in part on the different rules.

Although the message database 412, the rules database 414, and the facility information database 416 are described as databases, those skilled in the art will appreciate that they may comprise any data structure. The databases may be a single data structure or multiple data structures. Further, the data structures may be located at any digital device (e.g., message database 412 may be stored with the network device 108).

Further, although modules are depicted in FIG. 4 as being a part of the alert server 102, those skilled in the art will appreciate that the modules may be located at any digital device or combination of digital devices. For example, emergency messages to include in emergency information may be stored in the network device 108. As such, the network device 108 may comprise the custom emergency message module 410 and the message database 412. In another example, an administrator or other authorized user may construct or generate one or more messages to be included in emergency information before an emergency occurs. The messages may be constructed or generated by the custom emergency message module 410 at the network device 108 and/or the emergency administrator device 106. The messages may be stored in the message database 412 on any digital device. When an emergency alert is received and the alert server 102 receives authorization, the alert server 102 may instruct the emergency administrator device 106 and/or the network device 108 to generate the emergency information based on the preconstructed messages and to provide the emergency information to the presentation device(s) 110A-C.

Those skilled in the art will appreciate that a module may comprise, individually or in combination with other modules, software, hardware, firmware, circuitry, or any combination thereof. Those skilled in the art will appreciate that the modules depicted in FIG. 4 are exemplary. The alert server 102 may comprise more or less modules than those depicted. For example, one or more modules of the alert server 102 may perform all or a portion of the functions of any other module.

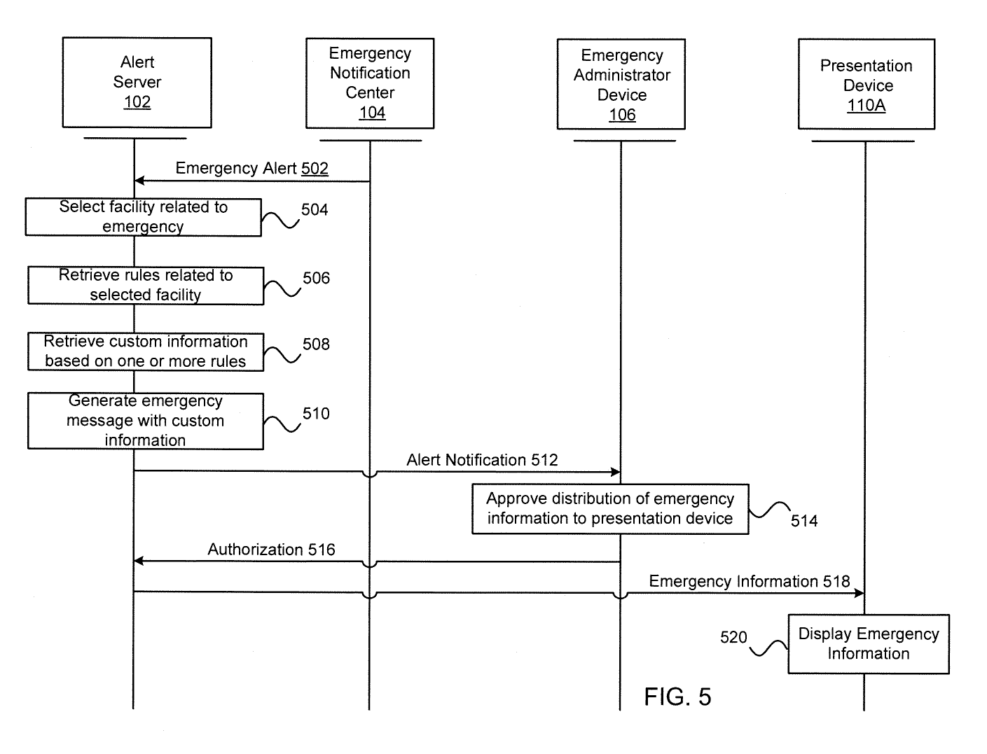

FIG. 5 is a flow diagram depicting the communication between the alert server 102, emergency notification center 104, emergency administrator device 106, and presentation device 110A in some embodiments. In step 502, the emergency notification center 104 provides an emergency alert to the alert server 102. The emergency alert may comprise information regarding an emergency condition (e.g., type, location, and degree of seriousness of the emergency) as well as information by those affected by the emergency alert. For example, an emergency alert may comprise information regarding geographic area that may be affected by a number of tornados.

The alert server 102 may receive the emergency alert from the emergency notification center 104 and select one or more facilities related to the emergency. For example, the facility selection module 404 may identify and select a plurality of facilities that may be affected by the emergency condition. In one example, the facility selection module 404 retrieves geographic location information from the emergency alert and searches for all facilities associated with the geographic location which may receive emergency information from the facility information database 416.

In step 506, the alert server 102 retrieves rules related to the selected facilities. In one example, the rules module 406 retrieves rules form the rules database 414 which may indicate when emergency information is to be sent to one or more of the selected facilities, authorization(s) required, and messages to include in the emergency information.

In step 508, the alert server 102 generates the emergency information by retrieving custom information based on one or more rules. In one example, the custom emergency message module 410 retrieves preconstructed messages and information based on the message rules from the rules module 406. In step 510, the alert server 102 generates emergency information including one or more custom emergency messages. Those skilled in the art will appreciate that generation of the emergency information may occur at any time (e.g., while waiting for authorization or after authorization is received) and that any device may generate the emergency information (e.g., the alert server 102, the emergency administrator device 106, or a network device 108).

In some embodiments, the custom emergency message module 410 may also generate an alert notification that summarizes or includes the emergency alert to send to one or more emergency administrator devices 106 for authorization. What to include and where to send the alert notification may be based, in part, on the authorization rules.

In step 512, the alert server 102 provides the alert notification to the emergency administrator device 106 for authorization. In one example, the emergency transmission module 408 provides the alert notification to one or more of the emergency administrator devices 106 based on authorization rules.

In step 514. The emergency administrator device 106 approves or provides authorization to distribute emergency information to one or more presentation devices 110A. In some embodiments, once the alert server 102 provides the alert notification to the emergency administrator device 106, the alert server 102 may also provide an alert to one or more authorized users (e.g., automated telephone call, SMS text message, beeper alert, or the like). The authorized user may then review the information associated with the alert notification (e.g., emergency condition, emergency alert, or other information from a variety of sources including the emergency notification center 104, local radio, or other media). In step 518, the emergency administrator device 106 provides the authorization to the alert server 102.

In step 518, the alert server 102 receives the authorization and if the authorization meets the requirements of the authorization rule(s), the alert server 102 provides emergency information to the presentation device 110A. In one example, the emergency transmission module 408 provides the emergency information to the presentation device 110A. In some embodiments, the alert server 102 provides different emergency information to different facilities and to different presentation devices within the same facility.

In step 520, the presentation device 110a displays and/or plays the emergency information received from the alert server 102.

In some embodiments, due to the sensitive nature of the circumstances involved in an emergency, the importance of securing every link in the information chain may be stressed. As a result, the inbound alert network may be sandboxed to prevent entry points for unauthorized access.

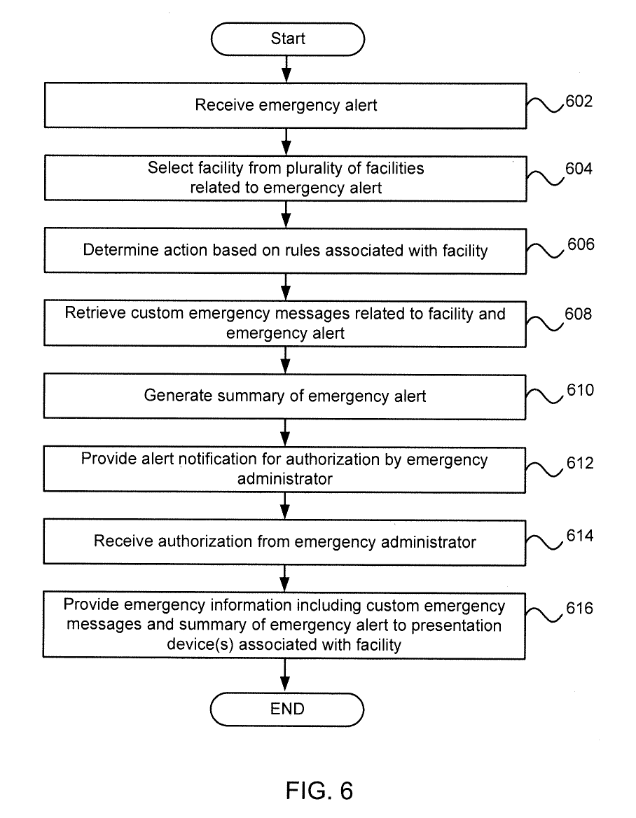

FIG. 6 is a flow chart to present emergency information at a presentation device in some embodiments. In step 602, a notification receiver module 402 receives an emergency alert. The emergency alert may be received from an authorized user, an authority (e.g., police officer, fire chief, authorized member of FEMA, or the like), or an emergency notification center 104. In one example, the notification receiver module 402 may receive an emergency broadcast from the emergency notification center 104.

In step 604, the facility selection module 404 selects one or more facilities from a plurality of facilities (e.g., in the facility information database 416) based on the emergency alert. In some embodiments, the facility selection module 404 retrieves geographical information from the emergency alert and uses the geographical information to determine facilities that might be affected. In one example, the facility selection module 404 may retrieve geocoded data from the emergency alert using a lookup table. The facility selection module 404 may also retrieve additional information to identify facilities that may be affected (e.g., from the emergency notification center 104, collect information from the radio, and/or the Internet).

In step 606, the rules module 406 determines action based on distribution rules associated with the facility. In some embodiments, the rules module 406 may determine that the emergency alert is unrelated to the facility or that the facility is closed.

In step 608, the custom emergency message module 410 may retrieve custom emergency messages related to a facility and the emergency alert. Based, at least in part, on the emergency alert and/or the identified facilities, the custom emergency message module 410 may retrieve custom emergency messages (e.g., images, audio, or video) and generate the emergency information. The custom emergency message module 410 may also include information from or associated with the emergency alert in the emergency information.

In step 610, the emergency transmission module 408 generates a summary of the emergency alert to create an alert notification which is provided to the emergency administrator device 106 or other authorized device to receive authorization to provide the emergency information. In some embodiments, the emergency transmission module 408 authenticates the emergency administrator device 106 (e.g., username, password, encryption key or the like) and may establish a secure connection (e.g., via vpn and/or HTTPS) with the emergency administrator device 106. The emergency transmission module 408 may also provide sounds, messages, images, or video to attract the attention of an authorized user. In step 612, the emergency transmission module 408 provides the alert notification to the emergency administrator device 106.

In step 614, the emergency transmission module 408 receives authorization from the emergency administrator (e.g., via the emergency administrator device 106). In some embodiments, the emergency transmission module 408 tracks the requirements of the authorization rules and only distributes emergency information when all requirements are met.

In step 616, the emergency transmission module 408 provides emergency information including custom emergency messages and a summary of the emergency alert to presentation device(s) associated with the facility.

Those skilled in the art will appreciate that the notification receiver module 402, the facility selection module 404, the rules module 406, the emergency transmission module 408, and the custom emergency module 410 may be on the same digital device or on multiple digital devices. For example, the alert server 102 may comprise the notification receiver module 402, the facility selection module 404, and the emergency transmission module 408. A network device 108 may comprise the rules module 406 and the custom emergency message module 410. For example, the alert server 102 may provide the alert notification to the emergency administrator device 106 as well as an indication to the network device 108 to begin generation of the emergency information. The custom emergency message module 410 on the network device 108 may retrieve custom messages from the message database 412 and collect information from the alert server 102 and/or emergency notification center 104 to prepare for distribution of the emergency information. Once the alert server 102 receives authorization form the emergency administrator device 106, the alert server 102 may provide the network device 108 and command to distribute the emergency information to one or more presentation devices.

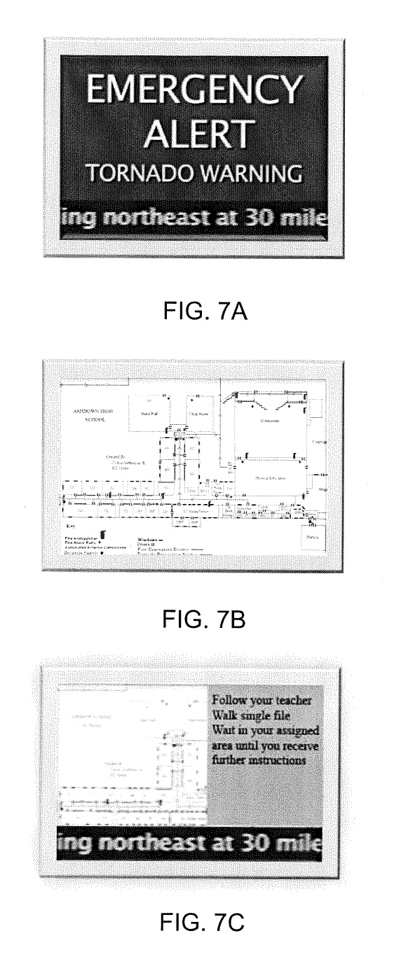

FIG. 7A-7C depict different displays presenting different emergency information in some embodiments. Different information may be displayed at different facilities, different buildings at the same facility, and/or different presentation devices. FIG. 7A depicts a display indicating the type of emergency condition (i.e., tornado warning) and includes text scrolling at the base of the display. The text that is scrolling at the base of the display may be received from an emergency notification center 104 or an emergency alert. For example, when generating the emergency information, the alert server 102 and/or the network device 108 may retrieve images from storage (e.g., the display depicting the text “tornado warning”) and present the text from the emergency alert or emergency notification center 104. The emergency information may be formatted and stored prior to the emergency. In some embodiments, the alert server 102 and/or the network device 108 may pull additional information from the emergency notification center 104. For example, the network device 108 may access a web site associated with the emergency notification center 104 and provide and/or summarize the text to be scrolled at the bottom of the display.

FIG. 7B depicts a display indicating a map of a floor of a building including an evacuation route. Those skilled in the art will appreciate that a different map may be displayed on different floors and/or in different parts of a facility or building. In some embodiments, the network device 108 stores different maps and customizes different messages and/or emergency information templates to be retrieved as needed. Each different message and/or emergency information template may be previously associated with one or more presentation devices. As a result, in an emergency, the network device 108 may retrieve the necessary emergency information, include any additional information (if any) and provide the emergency information to the respective presentation devices.

In some embodiments, the display of a presentation device may change over a predetermined period of time. For example, a display may depict the image shown on FIG. 7A for a predetermined time and then depict the image shown on FIG. 7B for a predetermined period of time. Other information may also be displayed. The depictions of the display may loop between multiple images or present different information.

In various embodiments, different types of information may be depicted in the same presentation device. FIG. 7C depicts a display indicating a map of a building, a scroll of text regarding the emergency condition and instructions. Each portion of the emergency information and different screens can be customized. In one example, an administrator may customize the emergency information based on the intended audience (e.g., school children of age 8), the emergency, the facility, or any other information.

Those skilled in the art will appreciate that audio may also be added thereby allowing a radio emergency alert or similar audio to be played via speakers. The radio emergency alert may be retrieved or received from the emergency notification center 104 and/or a radio station. In some embodiments, an administrator or other authorized personnel may provide audible information via speakers of the presentation devices (e.g., television speakers, PA devices, or the like). The audible information may be previously stored (e.g., at the alert server 102 and/or the network device 108). In some embodiments, audio may be generated using text-to-speech technology. This text-to-speech conversion may be accomplished at the alert server 102, the network device 108, or on any other device.

FIG. 8 is a block diagram of an exemplary digital device 800. The digital device 800 comprises a processor 802, a memory system 804, a storage system 806, a communication network interface 808, an I/O interface 810, and a display interface 812 communicatively coupled to a bus 814. The processor 802 is configured to execute executable instructions (e.g., programs). In some embodiments, the processor 802 comprises circuitry or any processor capable of processing the executable instructions.

The memory system 804 is any memory configured to store data. Some examples of the memory system 804 are storage devices, such as RAM or ROM. The memory system 804 can comprise the ram cache. In various embodiments, data is stored within the memory system 804. The data within the memory system 804 may be cleared or ultimately transferred to the storage system 806.

The storage system 806 is any storage configured to retrieve and store data. Some examples of the storage system 806 are flash drives, hard drives, optical drives, and/or magnetic tape. In some embodiments, the digital device 800 includes a memory system 804 in the form of RAM and a storage system 806 in the form of flash data. Both the memory system 804 and the storage system 806 comprise computer readable media which may store instructions or programs that are executable by a computer processor including the processor 802.

The communication network interface (corn. network interface) 808 can be coupled to a network (e.g., communication network 114) via the link 816. The communication network interface 808 may support communication over an Ethernet connection, a serial connection, a parallel connection, or an ATA connection, for example. The communication network interface 808 may also support wireless communication (e.g., 802.11a/b/g/n, WiMax). It will be apparent to those skilled in the art that the communication network interface 808 can support many wired and wireless standards.

The optional input/output (I/O) interface 810 is any device that receives input from the user and output data. The optional display interface 812 is any device that is configured to output graphics and data to a display. In one example, the display interface 812 is a graphics adapter. It will be appreciated that not all digital devices 800 comprise either the I/O interface 810 or the display interface 812.

It will be appreciated by those skilled in the art that the hardware elements of the digital device 800 are not limited to those depicted in FIG. 8. A digital device 800 may comprise more or less hardware elements than those depicted. Further, hardware elements may share functionality and still be within various embodiments described herein. In one example, encoding and/or decoding may be performed by the processor 802 and/or a co-processor located on a GPU (i.e., Nvidia).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1. A method comprising:
receiving an emergency alert regarding an emergency condition affecting a geographic region;
selecting a facility from a plurality of facilities based on at least the geographic region;
generating an alert notification regarding the emergency alert;
providing the alert notification to the selected facility; and
receiving an authorization to provide emergency information to one or more digital devices associated with the facility.

2. The method of claim 1, wherein the emergency condition is associated with a condition selected from the group consisting of weather, terrorism, shooting, accident, or chemical spill.

3. The method of claim 1, wherein the emergency alert comprises information received from the NOAA Disaster Management Interoperability Services (DMIS).

4. The method of claim 1, wherein the emergency alert comprises information received from the Department of Homeland Security.

5. The method of claim 1, wherein the alert notification comprises a summary of the emergency condition and a proposed action to notify others.

6. The method of claim 1, wherein selecting the facility from the plurality of facilities based on at least the geographic region comprises searching a database for the plurality of facilities related to the geographic region and selecting one or more of the plurality of facilities that may be affected by the emergency condition.

7. The method of claim 1, wherein selecting the facility comprises selecting the facility at least partially based on a rule, wherein the rule comprises instructions that one or more facilities of the plurality of facilities should be contacted when the emergency condition has occurred in the geographic region.

8. The method of claim 1, wherein providing the alert notification to the selected facility comprises providing the alert notification to an authorization device associated with the facility.

9. The method of claim 1, further comprising sending emergency information to the one or more digital devices associated with the facility based on the authorization.

10. The method of claim 9, wherein the emergency information comprises audio, video, and images associated with the emergency condition.

11. The method of claim 9, wherein the emergency information comprises a map.

12. The method of claim 1, wherein the emergency information comprises customized messages generated by authorized users associated with the facility.

13. A system comprising:
a notification receiver module configured to receive an emergency alert regarding an emergency condition affecting a geographic region;
a facility selection module configured to select a facility from a plurality of facilities based on at least the geographic region; and
an emergency transmission module configured to generate an alert notification regarding the emergency alert, provide the alert notification to the selected facility; and receive an authorization to provide emergency information to one or more digital devices associated with the facility.

14. The system of claim 13, wherein the emergency condition is associated with a condition selected from the group consisting of weather, terrorism, shooting, accident, and chemical spill.

15. The system of claim 13, wherein the emergency alert comprises information received from the NOAA.

16. The system of claim 13, wherein the emergency alert comprises information received from the Department of Homeland Security.

17. The system of claim 13, wherein the alert notification comprises a summary of the emergency condition and a proposed action to notify others.

18. The system of claim 13, wherein the facility selection module configured to select the facility from the plurality of facilities based on at least the geographic region comprises the v configured to search a database for the plurality of facilities related to the geographic region and select one or more of the plurality of facilities that may be affected by the emergency condition.

19. The system of claim 13, wherein the facility selection module configured to select the facility comprises the facility selection module configured to select the facility at least partially based on a rule, wherein the rule comprises instructions that one or more facilities of the plurality of facilities should be contacted when the emergency condition has occurred in the geographic region.

20. The system of claim 13, wherein emergency transmission module configured to provide the alert notification to the selected facility comprises the emergency transmission module configured to provide the alert notification to an authorization device associated with the facility.

21. The system of claim 13, wherein the emergency transmission module is further configured to send emergency information to the one or more digital devices associated with the facility based on the authorization.

22. The system of claim 21, wherein the emergency information comprises audio, video, and images associated with the emergency condition.

23. The system of claim 21, wherein the emergency information comprises a map.

24. The system of claim 13, wherein the emergency information comprises customized messages generated by authorized users associated with the facility.

25. A computer readable medium comprising executable instructions, the instructions being executable by a processor to perform a method, the method comprising:
receiving an emergency alert regarding an emergency condition affecting a geographic region;
selecting a facility from a plurality of facilities based on at least the geographic region;
generating an alert notification regarding the emergency alert;
providing the alert notification to the selected facility; and
receiving an authorization to provide emergency information to one or more digital devices associated with the facility.
